(19) United States
(12) Patent Application Publication
(10) Pub. No.: US 2018/0342796 A1
(43) Pub. Date: Nov. 29, 2018

(54) VEHICLE COMPUTER APPARATUS

(71) Applicant: TAOGLAS LIMITED, Taoyuan City (TW)

(72) Inventors: Ronan Quinlan, Taoyuan City (TW); Wen-Chieh YANG, Taoyuan City (TW); Ming-Wei CHEN, Taoyuan City (TW)

(21) Appl. No.: 15/990,288

(22) Filed: May 25, 2018

(30) Foreign Application Priority Data
May 26, 2017 (TW) 106117542

(51) Int. Cl. H01Q 1/32; H01Q 5/342

(52) U.S. Cl. CPC H01Q 1/3275; H01Q 1/3233; H01Q 5/342

(57) ABSTRACT

A vehicle computer apparatus includes a circuit board (1) integrating an electronic control unit (10), a global navigation satellite system (20), a dedicated short-range communication technology system (30), a satellite digital audio radio service system (40), a long term evolution technology system (50), a wireless network system (60), a plurality of long term evolution technology antennas (2), a dedicated short-range communication technology antenna (3), a satellite digital audio radio service antenna (4), a global navigation satellite system antenna (5) and two wireless network antennas (6). Under the control of the electronic control unit (10), a variety of communication systems and a variety of navigation systems mentioned above can perform wireless calls, vehicle navigations and message transmissions between vehicles, so that the vehicle computer apparatus can be used in any country and place.

### BACKGROUND OF THE INVENTION

### Field of the Invention

The present invention relates to a vehicle computer, and especially relates to a vehicle computer apparatus integrating an electronic control unit, a variety of communication systems and a variety of navigation systems together.

### Description of the Related Art

It is known that a vehicle computer, a communication system and a navigation system are arranged in the vehicle now. The vehicle computer is used to monitor and sense every part of the vehicle, such as the control of the water temperature, the knock, the fuel injection, the oxygen content and the air inflow and so on. Once the vehicle has any fault or damage when driving, the microprocessor of the vehicle computer displays the status messages on the dashboard or the monitor to inform the driver. The communication system and the navigation system of the vehicle are externally arranged on the vehicle roof, such as the shark fin antenna. A circuit board is arranged inside the shark fin antenna. The circuit board is electrically connected to a GSM antenna and a GPS antenna respectively. The circuit board is connected to a transmission line which is connected to the center control of the vehicle computer. Therefore, when the GPS antenna receives signals, the signals are transmitted to the vehicle computer through the transmission line. After the vehicle computer processes the signals, the navigation can be displayed on the monitor of the vehicle. Or after the GSM antenna receives/transmits signals, the signals are transmitted to the vehicle computer through the same transmission line, the driver can communicate and talk.

Because the vehicle computer and the shark fin antenna are designed separately, the vehicle computer has to be connected to the shark fin antenna through the transmission line. Therefore, when manufacturing the vehicle, the transmission line has to be reserved, so that the production hour is increased and the cost of the material is increased. Moreover, when the vehicle is sold in different countries or places, the communication systems or navigation systems are different in every country or place, so that the communication system, the navigation system and the corresponding antennas inside the shark fin antenna have to be replaced, so that the structure of the shark fin antenna has to be re-designed.

### SUMMARY OF THE INVENTION

Therefore, the main object of the present invention is to solve the problems mentioned above. The present invention integrates the vehicle computer (the electronic control unit) with a variety of communication systems and a variety of navigation systems together to form a vehicle computer apparatus. The vehicle computer apparatus can perform the wireless calls, the vehicle navigation and the message transmission between vehicles, so that the vehicle computer apparatus can be used in any country and place.

In order to achieve the object mentioned above, the present invention provides a vehicle computer apparatus arranged in an installation space on a vehicle roof. The vehicle computer apparatus comprises a circuit board, a plurality of long term evolution technology antennas, a dedicated short-range communication technology antenna, a satellite digital audio radio service antenna, a global navigation satellite system antenna and two wireless network antennas. The long term evolution technology antennas are electrically connected to the circuit board, are arranged at four corners of the circuit board and form a polygonal area. The dedicated short-range communication technology antenna is electrically connected to the circuit board, is arranged in the polygonal area and is adjacent to one of the long term evolution technology antennas. The satellite digital audio radio service antenna is electrically connected to the circuit board, is arranged in the polygonal area and is adjacent to one of the long term evolution technology antennas. The global navigation satellite system antenna is electrically connected to the circuit board, is arranged in the polygonal area and is adjacent to one of the long term evolution technology antennas and the satellite digital audio radio service antenna. The two wireless network antennas are electrically connected to the circuit board, are arranged on edges of the polygonal area, are arranged between two of the long term evolution technology antennas and are arranged correspondingly to each other.

In an embodiment of the present invention, the long term evolution technology antennas and the two wireless network antennas are made of bended metal sheets.

In an embodiment of the present invention, a quantity of the long term evolution technology antennas is four.

In an embodiment of the present invention, the dedicated short-range communication technology antenna is an antenna in a nail shape.

In an embodiment of the present invention, the global navigation satellite system antenna and the satellite digital audio radio service antenna are planar antennas made of ceramics.

In an embodiment of the present invention, the vehicle computer apparatus further comprises an electronic control unit, a global navigation satellite system, a dedicated short-range communication technology system, a satellite digital audio radio service system, a long term evolution technology system and a wireless network system which are arranged on the circuit board. The global navigation satellite system is electrically connected to the electronic control unit and the global navigation satellite system antenna. The dedicated short-range communication technology system is electrically connected to the electronic control unit and the dedicated short-range communication technology antenna. The satellite digital audio radio service system is electrically connected to the electronic control unit and the satellite digital audio radio service antenna. The long term evolution technology system is electrically connected to the electronic control unit and the long term evolution technology antenna. The wireless network system is electrically connected to the electronic control unit and the two wireless network antennas.

In an embodiment of the present invention, the global navigation satellite system comprises an active circuit and an amplifying circuit which are electrically connected to the electronic control unit.

In an embodiment of the present invention, the global navigation satellite system further comprises a global positioning system, a global satellite navigation system, a Galileo positioning system, a Beidou satellite navigation system, a wide area augmentation system, an European geostationary navigation overlay service system and a multi-functional satellite augmentation system.

In an embodiment of the present invention, the satellite digital audio radio service system comprises an active circuit and an amplifying circuit which are electrically connected to the electronic control unit.

In an embodiment of the present invention, a depth of the installation space is between 15 mm˜20 mm.

In an embodiment of the present invention, a depth of the installation space is 17 mm.

In an embodiment of the present invention, the vehicle computer apparatus further comprises a power supply unit electrically connected to the electronic control unit.

In an embodiment of the present invention, the electronic control unit comprises a microprocessor, a memory, an input/output interface, an analog-digital converter and a shaping-driving circuit. The memory is electrically connected to the microprocessor. The input/output interface is electrically connected to the microprocessor. The analog-digital converter is electrically connected to the microprocessor. The shaping-driving circuit is electrically connected to the microprocessor.

### BRIEF DESCRIPTION OF DRAWING

FIG. 1 shows a block diagram of the vehicle computer apparatus of the present invention.

FIG. 2 shows an electrical connection diagram of the antenna and the circuit board of the vehicle computer apparatus of the present invention.

FIG. 3 shows an in use state diagram of the vehicle computer apparatus of the present invention.

### DETAILED DESCRIPTION OF THE INVENTION

Now please refer to following detailed description and figures for the technical content of the present invention:

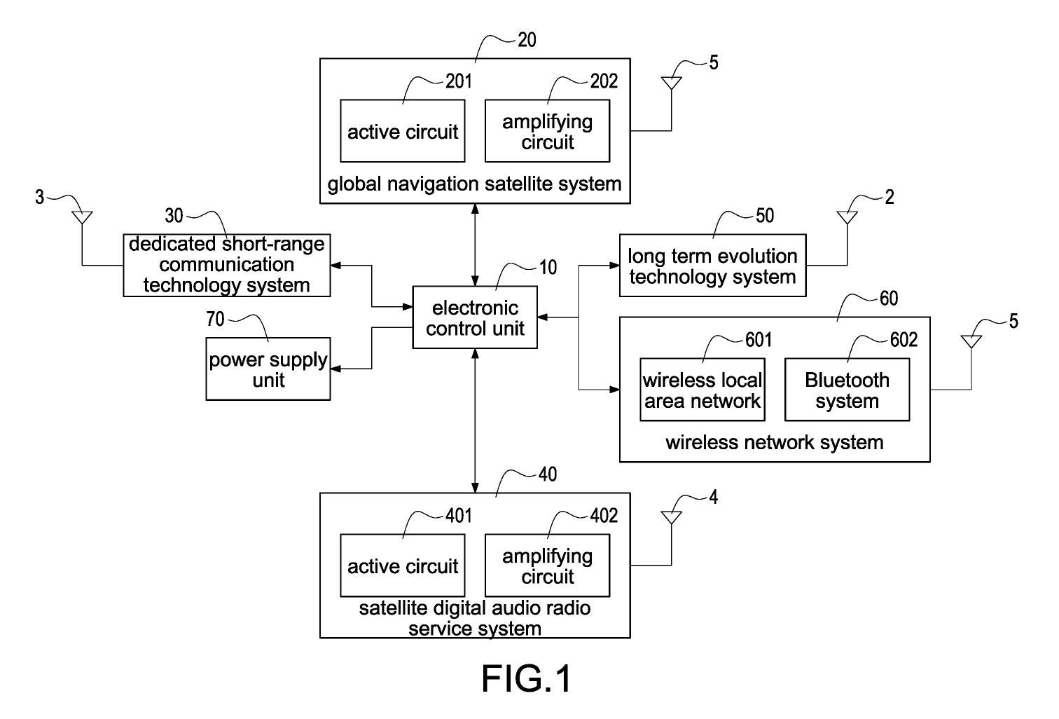

FIG. 1 shows a block diagram of the vehicle computer apparatus of the present invention. As shown in FIG. 1, a vehicle computer apparatus of the present invention comprises an electronic control unit (ECU) 10, a global navigation satellite system (GNSS) 20, a dedicated short-range communication (DSRC) technology system 30, a satellite digital audio radio service (SDARS) system 40, a long term evolution (LTE) technology system 50, a wireless network system 60 (comprising the WLAN/BT) and a power supply unit 70. The electronic control unit 10 integrates a variety of communication systems and a variety of navigation systems mentioned above to perform the wireless calls, the vehicle navigation and the data transmission between vehicles, so that the vehicle computer apparatus can be used in any country and place.

The electronic control unit 10 is also called the vehicle computer or the onboard computer and so on. The electronic control unit 10 is based on the related art technology, and moreover, the electronic control unit 10 is a micro-controller which is dedicated for the vehicles. Just like a related art computer, the electronic control unit 10 comprises a microprocessor (or a central processing unit, CPU), a memory (such as ROM or RAM), an input/out (I/O) interface, an analog-digital (A/D) converter and a shaping-driving circuit.

The global navigation satellite system 20 is electrically connected to the electronic control unit 10. The global navigation satellite system 20 comprises the related art, global, area and augmentation technology, such as a global positioning system (GPS), GLONASS (Russian abbreviation for “global satellite navigation system” or “global navigation satellite system”), Galileo positioning system, Beidou satellite navigation system, and the related art augmentation systems such as a wide area augmentation system (WAAS), European geostationary navigation overlay service (EGNOS) system and multi-functional satellite augmentation system (MSAS) and so on, which is a multi-system, multi-layer, multi-mode complex combination system. The global navigation satellite system 20 further comprises an active circuit 201 and an amplifying circuit 202 which are electrically connected to the electronic control unit 10.

The dedicated short-range communication technology system 30 is electrically connected to the electronic control unit 10. The dedicated short-range communication technology system 30 is a wireless communication technology in charge of establishing the message bi-directional transmission in links and between a vehicle and another vehicle to support the public security and private operation. The dedicated short-range communication technology system 30 is able to provide the high speed data transmission, and is able to ensure the low delay of the communication links and the reliability of the system, which is a communication technology dedicated for the vehicles. For example, the vehicle-to-vehicle (V2V) is a communication network between a vehicle and another vehicle. On the network, the data can be transmitted between a vehicle and another vehicle, so that one vehicle (car number 1) can inform another vehicle (car number 2) of the status and action of car number 1, and car number 1 is aware of the status and action of car number 2 as well. The receiving frequency of the dedicated short-range communication technology system 30 is between 5850 MHZ˜5925 MHZ.

The satellite digital audio radio service system 40 is electrically connected to the electronic control unit 10. The satellite digital audio radio service system 40 serves/operates in the S band of 2.3 GHZ, more specifically in the 2320 MHZ˜2345 MHZ. Besides, in the weak/poor reception area, the ground radio relay stations can be used to re-transmit signal waves to reinforce/improve the weak/poor signal problems. For example, mostly in the commercial areas of the city, because the buildings are too high and too dense, the wireless signals are blocked and weak. In FIG. 1, the satellite digital audio radio service system 40 further comprises an active circuit 401 and an amplifying circuit 402 which are electrically connected to the electronic control unit 10.

The long term evolution technology system 50 is a high speed wireless communication standard for mobile phones and data terminals in the telecommunication. In FIG. 1, the supporting frequency of the long term evolution technology system 50 is from 698 MHZ to 6 GHZ.

The wireless network system 60 is electrically connected to the electronic control unit 10. The wireless network system 60 comprises a wireless local area network (WLAN) 601 and a Bluetooth system 602. The wireless local area network 601 is a local area network which does not use any wire or transmission cable connection but uses radio waves as mediums for data transmission. Generally speaking, the transmission distance is just only several tens of meters. The backbone network (or the main network or the core network) of the wireless local area network 601 usually uses cables. Users of the wireless local area network 601 access the wireless local area network 601 through one wireless access point (WIFI) or a plurality of the wireless access points. The Bluetooth system 602 is a wireless technology standard for fixed and mobile apparatuses exchanging data in the short distance to form the personal area network (PAN). The Bluetooth system 602 uses the short-wave ultra-high frequency (UHF) radio waves. In FIG. 1, the wireless network system 60 supports the wireless local area network applications in the 2.4 GHZ˜5.8 GHZ frequency band.

The power supply unit 70 is electrically connected to the electronic control unit 10. The power supply unit 70 supplies the required power to the electronic control unit 10 and every system for operation.

According to the operation of the human-machine interface (not shown in FIG. 1), the electronic control unit 10 is configured to control the global navigation satellite system 20, the dedicated short-range communication technology system 30, the satellite digital audio radio service system 40, the long term evolution technology system 50 and the wireless network system 60 to perform respectively. The signals received by the systems are sent to the electronic control unit 10, and then the electronic control unit 10 processes the signals to achieve the communication and navigation control.

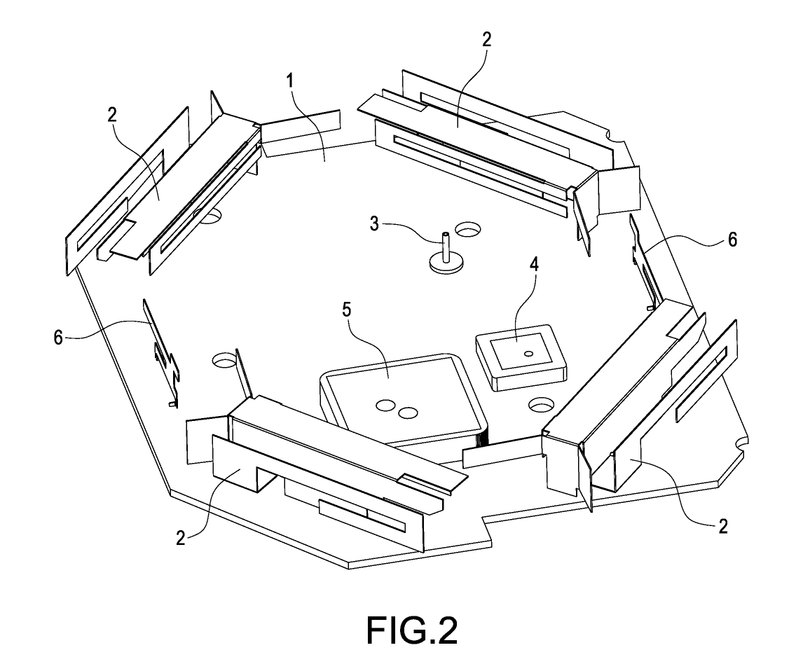

FIG. 2 shows an electrical connection diagram of the antenna and the circuit board of the vehicle computer apparatus of the present invention. Please refer to FIG. 1 at the same time. As shown in FIG. 2, the structure of the vehicle computer apparatus of the present invention comprises a circuit board 1, a plurality of long term evolution (LTE) technology antennas 2, a dedicated short-range communication (DSRC) technology antenna 3, a satellite digital audio radio service (SDARS) antenna 4, a global navigation satellite system (GNSS) antenna 5 and two wireless network antennas 6.

The circuit layouts of the electronic control unit 10, the global navigation satellite system 20, the dedicated short-range communication technology system 30, the satellite digital audio radio service system 40, the long term evolution technology system 50 and the wireless network system 60 are arranged on the circuit board 1.

The long term evolution technology antennas 2 are made of metal sheets which are pressed (or punched) and bended. The long term evolution technology antennas 2 are electrically connected to the circuit board 1, are arranged at four corners of the circuit board 1, form a polygonal area and are electrically connected to the long term evolution technology system 50. In FIG. 2, a quantity of the long term evolution technology antennas 2 is four, which can be used as multiple inputs and multiple outputs to increase transmission speed.

The dedicated short-range communication technology antenna 3 is electrically connected to the circuit board 1, is arranged in the polygonal area formed by the long term evolution technology antennas 2 and is adjacent to one of the long term evolution technology antennas 2. The dedicated short-range communication technology antenna 3 is electrically connected to the dedicated short-range communication technology system 30 and is in charge of establishing the message bi-directional transmission in links and between a vehicle and another vehicle to support the public security and private operation. In FIG. 2, the dedicated short-range communication technology antenna 3 is an antenna in a nail shape.

The satellite digital audio radio service antenna 4 is electrically connected to the circuit board 1, is arranged in the polygonal area formed by the long term evolution technology antennas 2 and is adjacent to one of the long term evolution technology antennas 2 as well. The satellite digital audio radio service antenna 4 is electrically connected to the satellite digital audio radio service system 40. In the weak/poor reception area, the ground radio relay stations can be used to re-transmit signal waves to reinforce/improve the weak/poor signal problems. In FIG. 2, the satellite digital audio radio service antenna 4 is a ceramic planar antenna.

The global navigation satellite system antenna 5 is electrically connected to the circuit board 1, is arranged in the polygonal area formed by the long term evolution technology antennas 2 and is adjacent to one of the long term evolution technology antennas 2 and the satellite digital audio radio service antenna 4. The global navigation satellite system antenna 5 is electrically connected to the global navigation satellite system 20 to perform the global, area and augmentation navigation and positioning signal processing. In FIG. 2, the global navigation satellite system antenna 5 is a ceramic planar antenna.

The two wireless network antennas 6 are electrically connected to the circuit board 1, are arranged on edges of the polygonal area formed by the long term evolution technology antennas 2, are arranged between two of the long term evolution technology antennas 2 and are arranged correspondingly to each other. The two wireless network antennas 6 are electrically connected to the wireless network system 60 to perform the transmission of the wireless local area network (WIFI) and Bluetooth signals. In FIG. 2, the two wireless network antennas 6 are made of metal sheets which are pressed (or punched) and bended.

In the operation of the human-machine interface (not shown in FIG. 1), the electronic control unit 10 is configured to control the global navigation satellite system 20, the dedicated short-range communication technology system 30, the satellite digital audio radio service system 40, the long term evolution technology system 50 and the wireless network system 60 to perform respectively. The signals received by the systems are sent to the electronic control unit 10, and then the electronic control unit 10 processes the signals to achieve the communication and navigation control.

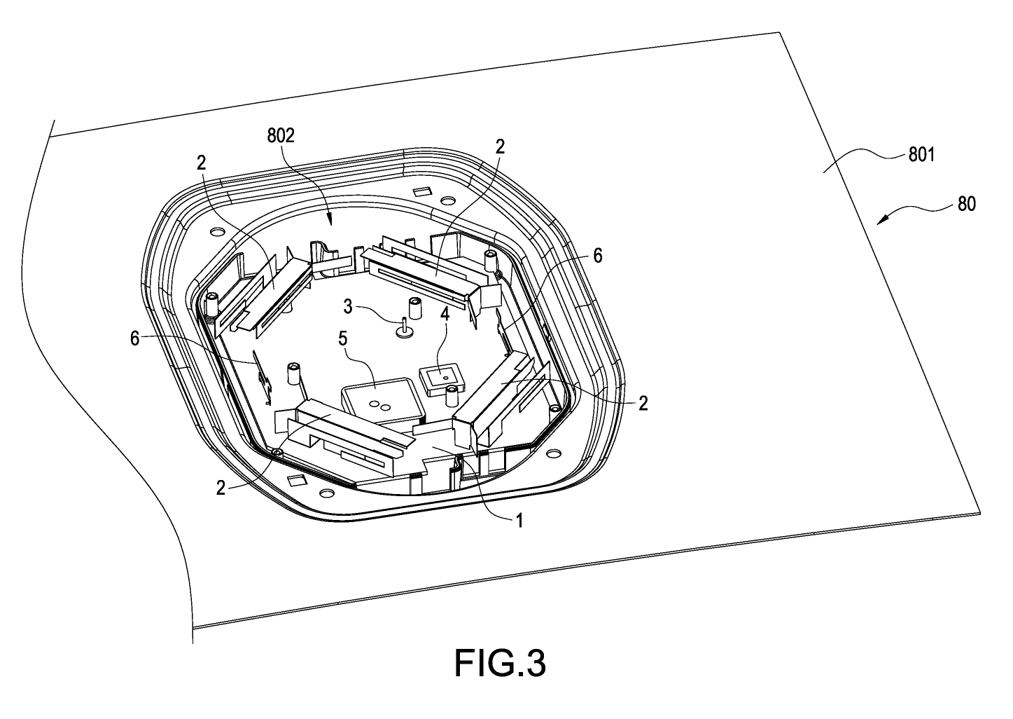

FIG. 3 shows an in use state diagram of the vehicle computer apparatus of the present invention. As shown in FIG. 3, after the long term evolution technology antennas 2, the dedicated short-range communication technology antenna 3, the satellite digital audio radio service antenna 4, the global navigation satellite system antenna 5 and the two wireless network antenna 6 are electrically connected to and are arranged on the circuit board 1 of the vehicle computer apparatus of the present invention, the circuit board 1 is arranged on a vehicle roof 801 of a vehicle 80. At the same time, an installation space 802 is reserved on the vehicle roof 801. After the circuit board 1 of the vehicle computer apparatus is arranged in the installation space 802, the protruding design of the related art shark fin antenna does not exist outside the vehicle roof 801 of the vehicle 80. In FIG. 3, a depth of the installation space 802 is between 15 mm˜20 mm. For example, the depth of the installation space 802 is 17 mm.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A vehicle computer apparatus arranged in an installation space (802) on a vehicle roof (801), the vehicle computer apparatus comprising:
a circuit board (1);
a plurality of long term evolution technology antennas (2) electrically connected to the circuit board (1), arranged at four corners of the circuit board (1) and forming a polygonal area;
a dedicated short-range communication technology antenna (3) electrically connected to the circuit board (1), arranged in the polygonal area (1) and adjacent to one of the long term evolution technology antennas (2);
a satellite digital audio radio service antenna (4) electrically connected to the circuit board (1), arranged in the polygonal area and adjacent to one of the long term evolution technology antennas (2);
a global navigation satellite system antenna (5) electrically connected to the circuit board (1), arranged in the polygonal area and adjacent to one of the long term evolution technology antennas (2) and the satellite digital audio radio service antenna (4); and
two wireless network antennas (6) electrically connected to the circuit board (1), arranged on edges of the polygonal area, arranged between two of the long term evolution technology antennas (2) and arranged correspondingly to each other.

2. The vehicle computer apparatus of claim 1, wherein the long term evolution technology antennas (2) and the two wireless network antennas (6) are made of bended metal sheets.

3. The vehicle computer apparatus of claim 1, wherein a quantity of the long term evolution technology antennas (2) is four.

4. The vehicle computer apparatus of claim 1, wherein the dedicated short-range communication technology antenna (3) is an antenna in a nail shape.

5. The vehicle computer apparatus of claim 1, wherein the global navigation satellite system antenna (5) and the satellite digital audio radio service antenna (4) are planar antennas made of ceramics.

6. The vehicle computer apparatus of claim 1 further comprising:
an electronic control unit (10) arranged on the circuit board (1);
a global navigation satellite system (20) arranged on the circuit board (1) and electrically connected to the electronic control unit (10) and the global navigation satellite system antenna (5);
a dedicated short-range communication technology system (30) arranged on the circuit board (1) and electrically connected to the electronic control unit (10) and the dedicated short-range communication technology antenna (3);
a satellite digital audio radio service system (40) arranged on the circuit board (1) and electrically connected to the electronic control unit (10) and the satellite digital audio radio service antenna (4);
a long term evolution technology system (50) arranged on the circuit board (1) and electrically connected to the electronic control unit (10) and the long term evolution technology antenna (2); and
a wireless network system (60) arranged on the circuit board (1) and electrically connected to the electronic control unit (10) and the wireless network antenna (6).

7. The vehicle computer apparatus of claim 6, wherein the global navigation satellite system (20) comprises:
an active circuit (201) electrically connected to the electronic control unit (10); and
an amplifying circuit (202) electrically connected to the electronic control unit (10).

8. The vehicle computer apparatus of claim 7, wherein the global navigation satellite system (20) further comprises a global positioning system, a global satellite navigation system, a Galileo positioning system, a Beidou satellite navigation system, a wide area augmentation system, an European geostationary navigation overlay service system and a multi-functional satellite augmentation system.

9. The vehicle computer apparatus of claim 6, wherein the satellite digital audio radio service system (40) comprises:
an active circuit (401) electrically connected to the electronic control unit (10); and
an amplifying circuit (402) electrically connected to the electronic control unit (10).

10. The vehicle computer apparatus of claim 1, wherein a depth of the installation space (802) is between 15 mm˜20 mm.

11. The vehicle computer apparatus of claim 9, wherein a depth of the installation space (802) is 17 mm.

12. The vehicle computer apparatus of claim 6 further comprising:
a power supply unit (70) electrically connected to the electronic control unit (10).

13. The vehicle computer apparatus of claim 6, wherein the electronic control unit (10) comprises
a microprocessor;
a memory electrically connected to the microprocessor;
an input/output interface electrically connected to the microprocessor;
an analog-digital converter electrically connected to the microprocessor; and
a shaping-driving circuit electrically connected to the microprocessor.
